(19) United States
(12) Patent Application Publication
(10) Pub. No.: US 2012/0189509 A1
(43) Pub. Date: Jul. 26, 2012

(54) AUTOMATIC ANALYZING METHOD AND SYSTEM FOR TEST STRIPS

(75) Inventor: Hsiung Hsiao, HsinChu City (TW)

(73) Assignees: Middleland Sensing Technology Inc., HsinChu City (TW); Hsiung Hsiao, HsinChu City (TW)

(21) Appl. No.: 13/109,095

(22) Filed: May 17, 2011

(30) Foreign Application Priority Data
Jan. 20, 2011 (TW) 100102125

(51) Int. Cl. G01N 21/78; G06K 9/00; G06K 9/68

(52) U.S. Cl. 422/400; 382/218; 382/165

(57) ABSTRACT

An automatic analyzing method for test strips includes steps of: providing a test strip unit at least having a reacting region and an image calibration region; capturing an image of the test strip unit; analyzing the image so as to obtain a first image signal of an image calibration region and a second image signal of a reacting region; comparing the first image signal with a standard signal so as to obtain image signal calibration parameters; calibrating the second image signal by applying the image signal calibration parameters so as to obtain a third image signal; and comparing the third image signal with data in a database so as to obtain a corresponding parameter values. The present invention also provides an automatic analyzing method for test strips.

### FIELD OF THE INVENTION

The present invention relates to an analyzing system for test strips and an analyzing method thereof, and more particularly to an automatic analyzing system for test strips and an automatic analyzing method thereof.

### BACKGROUND OF THE INVENTION

A conventional test strip kit includes a standard color interpretation table and test strips with reacting regions. The standard color interpretation table is consisted of a plurality of standard colors and a plurality of parameter values corresponding to the standard colors. The reacting region of a test strip is composed of multiple reagent pads used to contact with a sample fluid, and color of the reacting regions will be correspondingly changed according to concentration of certain constituent of the fluid.

When a user uses the conventional test strip, generally, the sample fluid contacts with the reagent pads of the reacting region. After the reaction is completed, the color of each reagent pad is compared with the standard colors of the color interpretation table, and corresponding parameter values can be determined.

The above steps of reading a test strip rely on manual work, which is not only time-consuming but also has a large possibility of artificially misreading. A test strip scanning machine can also be used for color reading in an automatic way. However, a test strip is read by a light scanning process, in order to assure accuracy of scanning results, test strip scanners generally have large sizes and expensive components, hence, reducing their convenience and popularity.

### SUMMARY OF THE INVENTION

The present invention provides an automatic analyzing method for test strips which includes steps of: providing a test strip unit at least having a reacting region and an image calibration region; capturing an image of the test strip unit; analyzing the image so as to obtain a first image signal of a comparing area image and a second image signal of a reacting area image; comparing the first image signal with a standard signal so as to obtain image signal calibration parameters; calibrating the second image signal by applying the image signal calibration parameters so as to obtain a third image signal; and comparing the third image signal with data in a database so as to obtain a corresponding parameter values. The present invention also provides an automatic analyzing method for test strips.

The present invention also provides an automatic analyzing method for test strips which includes steps of: providing a test strip unit having a color-capturing calibration region and a reacting region; capturing an image of the test strip unit; analyzing the image so as to obtain a first image signal of color-capturing calibration region and a second image signal of a reacting region; comparing the first image signal with a standard signal so as to obtain image signal calibration parameters; calibrating the second image signal by applying the image signal calibration parameters so as to obtain a third image signal; and comparing the third image signal with data in a database so as to obtain a corresponding parameter values.

The present invention also provides an automatic analyzing method for test strips which includes steps of: providing a test strip unit having sample color calibration region which is calibration region for the color of a sample fluid and a reacting region; capturing an image of the test strip unit; analyzing the image so as to obtain a first image signal of the sample color calibration region and a second image signal of the reacting region; comparing the first image signal with a background color signal so as to obtain image signal calibration parameters; calibrating the second image signal by applying the image signal calibration parameters so as to obtain a third image signal; and comparing the third image signal with data in a database so as to obtain corresponding parameter values.

The present invention also provides an automatic analyzing system for test strips which includes a test strip unit, an image capturing unit, a signal processing unit and a storage unit. The test strip unit has a reacting region, an image calibration region and a plurality of marks for positioning and alignment. The image capturing unit is configured to capture an image of the test strip unit. The signal processing unit is configured to process image signals and is electronically connected to the image capturing unit. The storage unit is electronically connected to the signal processing unit. The image capturing unit captures the image of the test strip unit and analyzes an image of the image calibration region so as to generate calibration parameters, an image of the reacting region can be calibrated by the calibration parameters.

A purpose of the present invention is to provide an automatic analyzing system for test strips.

Another purpose of the present invention is to provide an automatic analyzing method for test strips.

Another purpose of the present invention is to provide an automatic analyzing method for test strips which adopts positioning and alignment marks on the test strip to calibrate the image of the test strip, thereby improving accuracy of reading value of the test strip.

Another purpose of the present invention is to provide an automatic analyzing method for test strips which adopts positioning and alignment marks on the test strip to calibrate the image of the test strip, thereby avoiding a misreading problem caused by an image with distortion and wrong positioning.

Another purpose of the present invention is to provide a method which compares the image of an image-capturing calibration region of the test strip unit with the standard parameters, so as to obtain calibration parameters used as a basis for calibrating the reacting region. In such way, the influence of chromatic aberration generated by the image capturing unit and the color of the sample fluid itself can be reduced, and hence, eliminating the complexity of the system.

The automatic analyzing system for test strip of the present invention has a low cost and a small size. The automatic analyzing system for test strips can be widely used in mobile phones, personal digital assistants (PDAs), portable personal computers or other electronic devices, which increases mobility and convenience.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a structural, schematic view of a system according to an embodiment of the present invention.

FIG. 2 is a flow chart of a method according to an embodiment of the present invention.

FIG. 3 is a schematic view of a system according to another embodiment of the present invention.

FIG. 4 is a schematic view of a system according to another embodiment of the present invention.

### BRIEF DESCRIPTION OF THE DRAWINGS

The above objects and advantages of the present invention will become more readily apparent to those ordinarily skilled in the art after reviewing the following detailed description and accompanying drawings, in which:

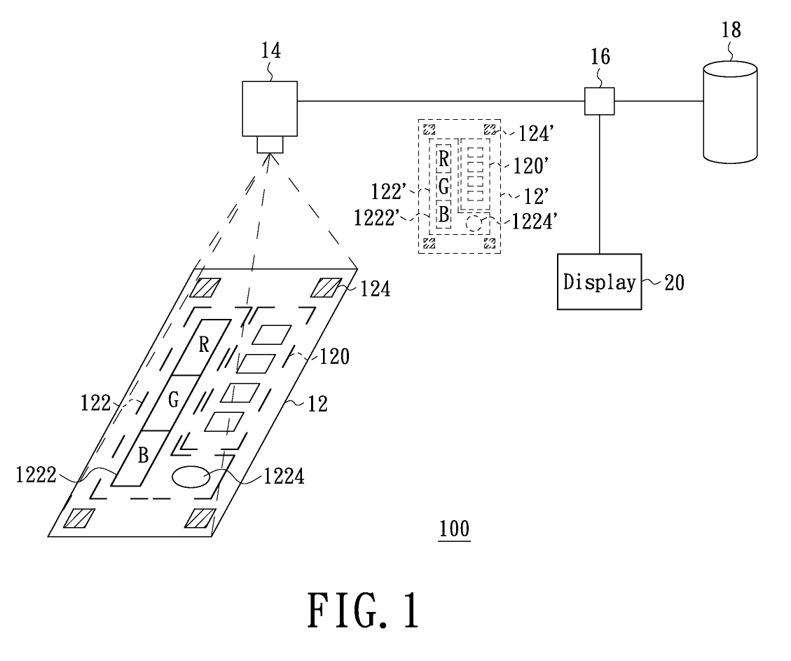

FIG. 1 is a structural, schematic view of a system according to an embodiment of the present invention.

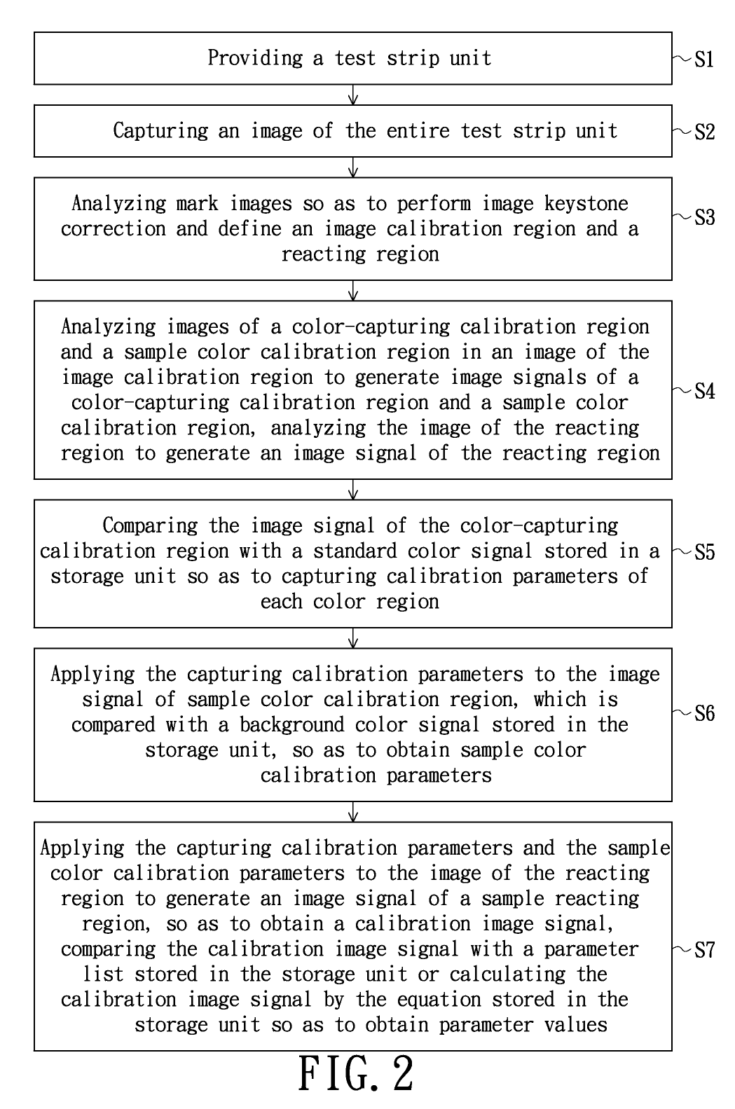

FIG. 2 is a flow chart of a method according to an embodiment of the present invention.

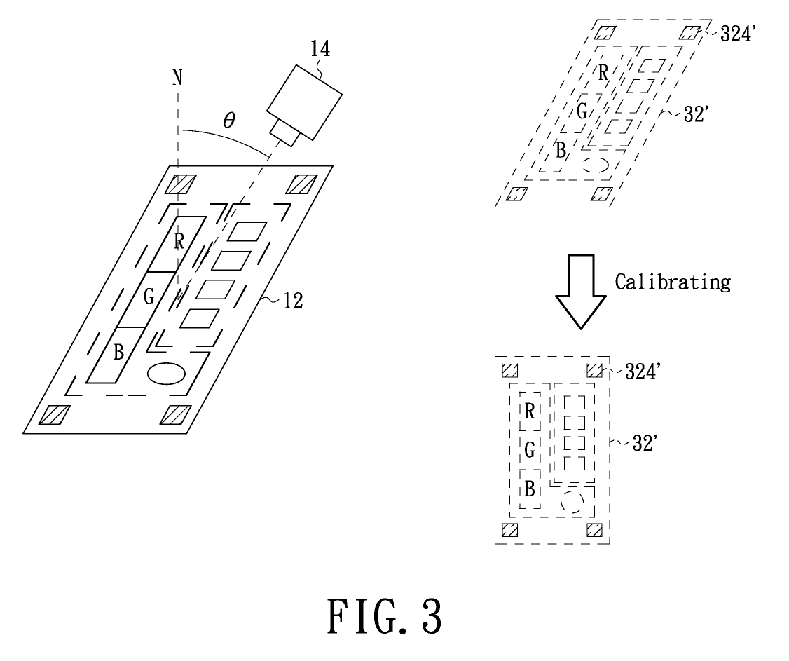

FIG. 3 is a schematic view of a system according to another embodiment of the present invention.

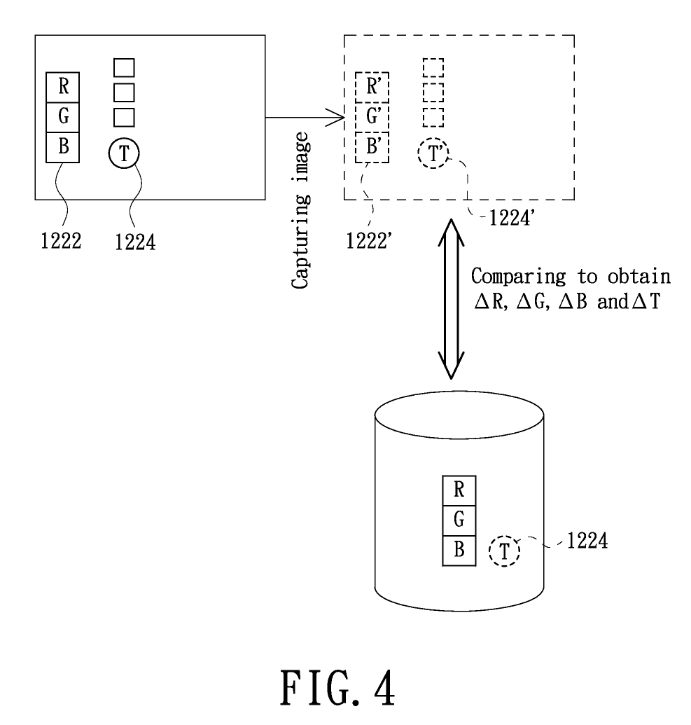

FIG. 4 is a schematic view of a system according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention discloses an automatic analyzing system for test strips and an automatic analyzing method for test strips. FIG. 1 is a structural, schematic view of a system according to an embodiment of the present invention. As shown in steps of FIG. 2, an automatic analyzing system for test strip 100 includes a test strip unit 12, an image capturing unit 14, a signal processing unit 16 and a storage unit 18. The test strip unit 12 has a reacting region 120, an image calibration region 122 and a plurality of marks 124 for positioning and alignment. The signal processing unit 16 is electronically connected to the image capturing unit 14 and the storage unit 18. The image calibration region 122 includes a color-capturing calibration region 1222 and a sample color calibration region 1224.

In the present embodiment, the test strip unit 12 is an allochroic test strip. In a detecting procedure, the reacting region 120 reacts with a sample fluid (not shown) and a color of the reacting region 120 changes. Generally, concentration of the sample fluid can affect the color of the reacting region 120 after the reacting region 120 contacts with the sample fluid.

Furthermore, the test strip unit 12 is used to detect, color of the sample fluid itself can affect color presented in the reacting region 120, for example, when the sample fluid is urine, the color presented in the reacting region 120 can be affected by the color of the urine itself. Therefore, in the present embodiment, the sample color calibration area 1224 in the image calibration region 122 is configured to contact the sample fluid and shows the color of the sample fluid itself, which is used as a calibration data for reading the color of the reacting region 120. Detail calibration method will be described in the following embodiment of automatic analyzing method for test strips.

As mentioned above, the test strip unit 12 includes a color-capturing calibration region 1222 and a sample color calibration region 1224. The color-capturing calibration region 1222 includes a plurality of colors at least including three primary colors red, green and blue. In the present embodiment, except three primary colors red, green and blue, the color-capturing calibration region 1222 of the image calibration region 122 can also include colors with the combinations of the three primary colors. Additionally, the color-capturing calibration region 1222 can be a standard color region standing for any concentration of certain constituent of the fluid.

Furthermore, the image capturing unit 14 can be a photographic assembly or an image scanning assembly.

In addition, the automatic analyzing system for test strips 100 further includes a display device 20 electronically connected to the signal processing unit 16. The display device 20 is configured to output result processed by the signal processing unit 16.

The storage unit 18 is configured to store a standard color signal, a background color signal and a parameter list or an equation used to compare with an image of the image calibration region. The standard color signal is configured to determine color shifts of the capturing colors captured by the image capturing unit 14. The background color signal is configured to judge the color of the sample fluid itself. The parameter list or the equation is configured to record corresponding relation between an image signal and a reading of the test strip.

Moreover, the test strip unit 12 at least has three marks 124 disposed on a periphery area of the test strip unit 12. The marks 124 are configured to assist the signal processing unit 16 to position and perform image keystone correction when the signal processing unit 16 processes the image signal. Detail usage of the marks 124 will be described in the following automatic analyzing method for test strips.

FIG. 2 is a flow chart of a method according to an embodiment of the present invention. Referring to FIG. 1 and FIG. 2, an automatic analyzing method for test strips according to an embodiment of the present invention has steps described below.

Firstly, as shown in step S1 of FIG. 2, the test strip unit 12 having a reacting region 120, an image calibration region 122 and a plurality of marks 124 is provided, and the reacting region 120 reacts with the sample fluid.

After that, as shown in step S2, the image capturing unit 14 captures an image 12′ of the entire test strip unit 12.

As shown in step S3, the image 12′ of the entire test strip unit 12 is transmitted to the signal processing unit 16, mark images 124′ of the test strip unit image 12′ are analyzed. In the present embodiment, the mark images 124′ are disposed on corner positions of the test strip unit image 12′ and are capable of assisting signal processing unit 16 to determine positions of an image 120′ of a reacting region and an image 122′ of the image calibration region in the test strip unit image 12′. Further, as shown in FIG. 3, when the image capturing unit 14 captures the image of the test strip unit 12, if a angle θ is formed between a normal direction of the test strip unit 12 and the image capturing unit 14, the image capturing unit 14 generally captures a distorted test strip image 32′, and mark images 324′ of the test strip image 32′ can assist the signal processing unit 16 to correct the above-mentioned distortion. Furthermore, the signal processing unit 16 can adjust the distorted test strip image 32′ to a test strip image 34′ without distortion according to the position relations between the mark images 324′. By the above-mentioned distortion adjusting steps, judging accuracy of positions of the reacting region image 120′ and the image 122′ of the image calibration region can be promoted.

Then, as shown in step S4 in FIG. 2, the signal processing unit 16 analyzes an image 1222′ of the color-capturing calibration region and an image 1224′ of the sample color calibration region in the image 122′ of the image calibration region to generate image signals of the color-capturing calibration region and the sample color calibration region. The image 120′ of the reacting region is analyzed to generate an image signal of the reacting region. In the present embodiment, the image signal of the color-capturing calibration region, the image signal of the sample color calibration area and the image signal of the reacting region are signals with red, green, blue pixels.

As mentioned above, the color-capturing calibration region 1222 is consisted of a plurality of color regions with different colors. Therefore, as shown in step S5 of FIG. 2, after obtaining image signal of each color region, the signal processing unit 16 compares the image signal of the color-capturing calibration region with the standard color signal stored in the storage unit 18, so as to obtain capturing calibration parameters of each color region. As shown in FIG. 4, in the present embodiment, the color-capturing calibration region 1222 of the test strip unit 12 includes red area, blue area and green area. The signal of the image 1222′ captured by the image capturing unit 14 in color-capturing calibration region are respectively R′, G′ and B′. The image processing unit compares the image 1222′ of the color-capturing calibration region with the standard color signals R, G and B stored in the storage unit 18, so as to respectively obtain a red capturing calibration parameter ΔR, a green capturing calibration parameter ΔG and a blue capturing calibration parameter ΔB.

Next, as shown in step S6 of FIG. 2, the capturing calibration parameters are applied to an image signal T′ of a sample color calibration region The image signal of the sample color calibration region is compared with the background color signal T stored in the storage unit 18, so as to obtain an sample color calibration parameter ΔT.

After that, as shown in step S7 of FIG. 2, the capturing calibration parameters and the sample color calibration parameters are applied to the image 120′ to generate an image signal of the reacting region, so as to obtain a calibration image signal. The calibration image signal is compared with the parameter list stored in the storage unit or is calculated by the equation stored in the storage unit, so as to obtain parameter values.

In summary, the present invention provides an automatic analyzing method for test strips which adopts the marks of the test strip unit to calibrate the image of the test strips, thereby improving accuracy of reading value of the test strips and avoiding a misreading problem caused by an image with distortion and wrong positioning.

Furthermore, the present invention further provides a method which compares the image of the image-capturing calibration region of the test strip unit with the standard parameters, so as to obtain calibration parameters used as a basis for calibrating the reacting region. In such way, the influence of chromatic aberration generated by the image capturing unit and the color of the sample fluid itself can be reduced, so that availability of the automatic analyzing system can be promoted.

The automatic analyzing system for test strips of the present invention has a low cost and a small size. The automatic analyzing system for test strips can be widely used in mobile phones, personal digital assistants, portable personal computers or other electronic devices, which increases mobility and convenience.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic analyzing method for test strips, comprising steps of:
providing a test strip unit at least having a reacting region and an image calibration region;
capturing an image of the test strip unit;
analyzing the image so as to obtain a first image signal of the image calibration region and a second image signal of the reacting region;
comparing the first image signal with a standard signal so as to obtain image signal calibration parameters;
calibrating the second image signal by applying the image signal calibration parameters so as to obtain a third image signal; and
comparing the third image signal with data in a database so as to obtain corresponding parameter values.

2. The automatic analyzing method for test strips according to claim 1, wherein the first image signal is an image signal of a color-capturing calibration region or an image signal of a sample color calibration region.

3. The automatic analyzing method for test strips according to claim 1, wherein the image signal calibration parameters are color-calibration parameters or sample color calibration parameters.

4. The automatic analyzing method for test strips according to claim 1, wherein the standard signal is a standard color signal or a background color signal.

5. The automatic analyzing method for test strips according to claim 1, wherein in the step of analyzing the image, position information of a plurality of positioning and alignment marks of the test strip unit is identified.

6. The automatic analyzing method for test strips according to claim 5, further comprising a step of defining images of the image calibration region and the reacting region by the position information of the positioning and alignment marks.

7. The automatic analyzing method for test strips according to claim 6, further comprising a step of calibrating image distortion by the position information of the positioning and alignment marks.

8. An automatic analyzing method for test strips, comprising steps of:
providing a test strip unit having a color-capturing calibration region and a reacting region;
capturing an image of the test strip unit;
analyzing the image so as to obtain a first image signal of the color-capturing calibration region and a second image signal of the reacting region;
comparing the first image signal with a standard signal so as to obtain image signal calibration parameters;
calibrating the second image signal by applying the image signal calibration parameters so as to obtain a third image signal; and
comparing the third image signal with data in a database so as to obtain corresponding parameter values.

9. The automatic analyzing method for test strips according to claim 8, wherein in the step of analyzing the image, position information of a plurality of positioning and alignment marks of the test strip unit is identified.

10. The automatic analyzing method for test strips according to claim 9, further comprising a step of defining images of the color-capturing calibration region and the reacting region by the position information of the positioning and alignment marks.

11. The automatic analyzing method for test strips according to claim 10, further comprising a step of calibrating image distortion by the position information of the positioning and alignment marks.

12. An automatic analyzing method for test strips, comprising steps of:
providing a test strip unit having a sample color calibration region and a reacting region;
capturing an image of the test strip unit;
analyzing the image so as to obtain a first image signal of a sample color calibration region and a second image signal of a reacting region;
comparing the first image signal with a background color signal so as to obtain image signal calibration parameters;
calibrating the second image signal by applying the image signal calibration parameters so as to obtain a third image signal; and
comparing the third image signal with data in a database so as to obtain corresponding parameter values.

13. The automatic analyzing method for test strips according to claim 12, wherein in the step of analyzing the image, position information of a plurality of positioning and alignment marks of the test strip unit is identified.

14. The automatic analyzing method for test strips according to claim 12, further comprising a step of defining images of the sample color calibration region and the reacting region by the position information of the positioning and alignment marks.

15. The automatic analyzing method for test strips according to claim 14, further comprising a step of calibrating image distortion by the position information of the positioning and alignment marks.

16. An automatic analyzing system for test strips, comprising:
a test strip unit having a reacting region, an image calibration region and a plurality of positioning and alignment marks;
an image capturing unit configured to capture an image of the test strip unit;
a signal processing unit configured to process image signals and electronically connected to the image capturing unit;
a storage unit electronically connected to the signal processing unit; wherein the image capturing unit captures the image of the test strip unit and analyzes an image of the image calibration region so as to generate calibration parameters, an image of the reacting region can be calibrated by the calibration parameters.

17. The automatic analyzing system for test strips according to claim 16, wherein the image calibration region further comprises a sample color calibration region and a color-capturing calibration region.

18. The automatic analyzing system for test strips according to claim 16, further comprising a display device electronically connected to the signal processing unit.

19. The automatic analyzing system for test strips according to claim 16, wherein the test strip unit has at least three marks.

20. The automatic analyzing system for test strips according to claim 16, wherein the image capturing unit is a photographic assembly or an image scanning assembly.
